(19) United States
(12) Patent Application Publication
(10) Pub. No.: US 2025/0242896 A1
(43) Pub. Date: Jul. 31, 2025

(54) FLOATING-TYPE WIND POWER GENERATION PLATFORM AND FLOATING-TYPE WIND POWER GENERATION SYSTEM

(71) Applicant: BITMAIN TECHNOLOGIES INC., Beijing (CN)

(72) Inventors: Guo WU, Beijing (CN); Mingliang HAO, Beijing (CN); Hongbo ZENG, Beijing (CN); Cheng LI, Beijing (CN); Qiwei BAI, Beijing (CN); Tuo GENG, Beijing (CN)

(21) Appl. No.: 19/093,057

(22) Filed: Mar. 27, 2025

Related U.S. Application Data
(63) Continuation of application No. PCT/CN2023/115558, filed on Aug. 29, 2023.

(30) Foreign Application Priority Data
Sep. 28, 2022 (CN) 202222583357.X

(51) Int. Cl. B63B 35/44; F03D 13/25

(52) U.S. Cl. CPC B63B 35/44; B63B 2035/446; F03D 13/256; F05B 2240/93

(57) ABSTRACT

The present application discloses a floating-type wind power generation platform and a floating-type wind power generation system. The floating-type wind power generation platform includes a first transverse connector and multiple floating support components, where the multiple floating support components are arranged at intervals on the water surface in a horizontal direction, and the first transverse connector includes a first connecting rod and an outward-extending plate, the first connecting rod has both ends connected to two adjacent floating support components, and the outward-extending plate extends from the outer side wall of the first connecting rod in a direction away from the center of the first connecting rod.

### CROSS-REFERENCE TO RELATED APPLICATIONS

The present application is a continuation of International Application No. PCT/CN2023/115558, filed on Aug. 29, 2023, which claims priority to Chinese Patent Application No. 202222583357.X, filed on Sep. 28, 2022. The aforementioned applications are hereby incorporated by reference in their entireties.

### FIELD

The present application relates to the field of wind power generation, particularly to a floating-type wind power generation platform and a floating-type wind power generation system comprising the floating-type wind power generation platform.

### BACKGROUND

In the related technology, the floating support component of a floating-type wind power generation platform is generally a box-beam-type pontoon or cylindrical tube, and the transverse connector for connecting bottoms of two adjacent floating support components is generally a cylindrical rod, which has the following shortcomings in specific applications:
although such transverse connector can provide structural force transfer effect, it has an insignificant effect in increase of viscous damping of the motion of the floating support component.

### SUMMARY

A first object of the present application is to provide a floating-type wind power generation platform, that aims to address the technical problem in the related technology where the connector for connecting two adjacent floating support components has an insignificant effect in increase of the viscous damping of the motion of the floating support components.

In order to achieve the above object, the present application provides a floating-type wind power generation platform, which includes a first transverse connector and at least two floating support components. The at least two floating support components are arranged at intervals on water surface in a horizontal direction to provide a mounting site for a wind turbine. The first transverse connector includes a first connecting rod and an outward-extending plate. Two ends of the first connecting rod are respectively connected to two adjacent floating support components, and the outward-extending plate extends from an outer side wall of the first connecting rod in a direction away from center of the first connecting rod.

In an embodiment, the first transverse connector includes two outward-extending plates, which respectively protrude from two opposite sides of the first connecting rod.

In an embodiment, the outward-extending plates extend horizontally from the outer side wall of the first connecting rod in the direction away from the center of the first connecting rod; and/or,
the first connecting rod is provided near bottoms of the floating support components.

In an embodiment, a position where the first connecting rod is connected with the outward-extending plate is a position where the outer side wall of the first connecting rod has a greatest horizontal distance from the center of the first connecting rod.

In an embodiment, a length of the outward-extending plate is less than or equal to a length of the first connecting rod.

In an embodiment, the first transverse connector further includes a reinforcing rib, which is connected to both the outer side wall of the first connecting rod and the outward-extending plate.

In an embodiment, the outward-extending plate has an upper surface and a lower surface that are set opposite to each other, the reinforcing rib include a first rib and/or a second rib, the first rib is connected with the outer side wall of the first connecting rod and the upper surface, and the second rib is connected with the outer side wall of the first connecting rod and the lower surface; and/or,
the first transverse connector includes at least two reinforcing rib spaced apart along the length of the first connecting rod.

In an embodiment, the outer side wall of the first connecting rod is cylindrical; and/or,
the first connecting rod includes a hollow rod body and at least two connecting plates that are cross-connected within the hollow rod body.

In an embodiment, the floating support components are a vertical cylindrical pontoon; or,
the floating support components include a hull and a support pole extending upward from a top of the hull for installing the wind turbine.

A second object of the present application is to provide a floating-type wind power generation system, which includes a wind turbine and the aforementioned floating-type wind power generation platform, where the wind turbine is installed on the floating support component.

The beneficial effects of the present application are as follows: the floating-type wind power generation platform and the floating-type wind power generation system provided in the present application provide an outward-extending plate that extends from the outer side wall of the first connecting rod and is set between two adjacent floating support components. In this way, when the floating-type wind power generation platform floats on water, it can increase the vortex motion in the flow field, converting more kinetic energy of the fluid into internal energy of the fluid. This increases the damping of the rocking motion of the floating-type wind power generation platform, reducing the movement amplitude of the floating-type wind power generation platform in waves. Since the present application may achieve the effect of increasing the damping of the rocking motion of the floating-type wind power generation platform simply by extending the outward-extending plates from the outer side wall of the first connecting rod, it is simple in structure, uses less material, and has a lower cost.

### BRIEF DESCRIPTION OF DRAWINGS

In order to more clearly explain technical solutions in embodiments of the present application or in the prior art, the drawings to be used in the description of the embodiments or the prior art will be briefly introduced below. Obviously, the drawings in the following description are only some embodiments of the present application, and other drawings may be obtained by those of ordinary skill in the art based on these drawings without creative labor.

FIG. 1 is a schematic diagram of a floating-type wind power generation platform provided in an Embodiment 1 of the present application.

FIG. 2 is a schematic structural diagram of a first transverse connector provided in an Embodiment 1 of the present application.

FIG. 3 is a schematic sectional view along A-A in FIG. 2.

FIG. 4 is a schematic diagram of a floating-type wind power generation system provided in an Embodiment 1 of the present application.

FIG. 5 is a schematic diagram of a floating-type wind power generation platform provided in an Embodiment 2 of the present application.

### DESCRIPTION OF REFERENCE NUMERALS

100—first transverse connector;
110—first connecting rod;
111—transverse connecting plate;
112—longitudinal connecting plate;
113—hollow rod body;
120—outward-extending plate;
121—upper surface;
122—lower surface;
130—reinforcing rib;
131—first rib;
132—second rib;
200—floating support component;
210—support pole;
300—second transverse connector;
400—wind turbine;
500—inclined connecting rod.

### DESCRIPTION OF EMBODIMENTS

The technical solutions of embodiments of the present application are hereinafter clearly and completely described with reference to the accompanying drawings in the embodiments of the present application. It is evident that the described embodiments are only some of embodiments of the present application, not all of them. Other embodiments obtained by those skilled in the art based on embodiments of the present application without creative labor fall within the protection scope of the present application.

It should be noted that all directional indications (such as up, down, left, right, front, back, etc.) in the embodiments of the present application are only used to explain the relative positional relationships and motion conditions between components under a specific posture. If the specific posture changes, then these directional indications will also change correspondingly.

It should also be noted that when an element is referred to as being “fixed to” or “provided on” another element, it can be directly on the another element or there may be an intermediate element present between them. When one element is referred to as being “connected” to another element, it can be directly connected to the another element or indirectly connected to the another element through an intermediate element.

Additionally, descriptions involving “first,” “second,” etc., in the present application are solely for descriptive purpose and should not be construed as indicating or implying relative importance or implicitly specifying the number of indicated technical features. Therefore, features defined by “first” or “second” can explicitly or implicitly include at least one such feature. Furthermore, technical solutions between embodiments can be combined, but such combinations must be based on the premise that they can be implemented by a person of ordinary skill in the art. If the combination of technical solutions results in contradictions or cannot be realized, such a combination shall be deemed non-existent and are not within the scope of protection claimed in the present application.

### Embodiment 1

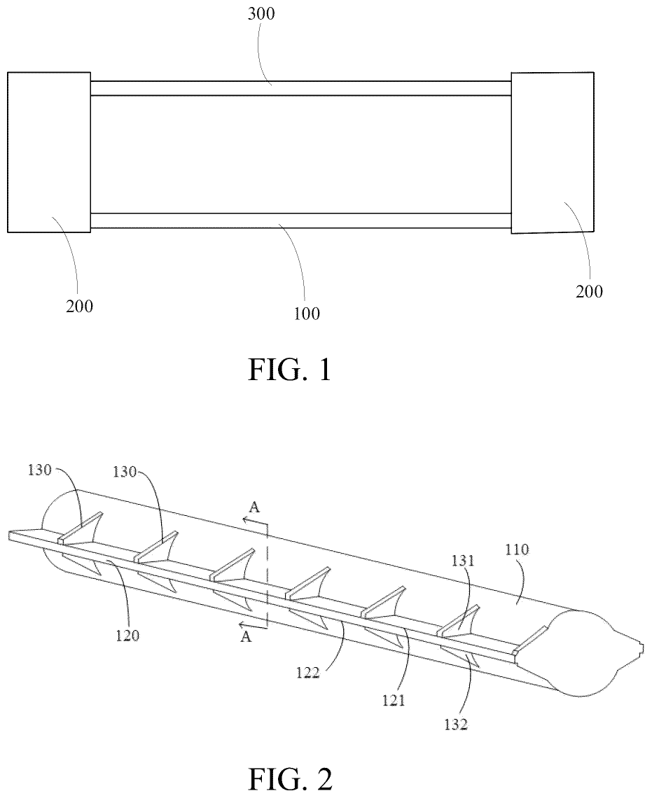

Referring to FIGS. 1, 2, and 4, the floating-type wind power generation platform provided in Embodiment 1 of the present application includes a first transverse connector 100 and at least two floating support components 200. The at least two floating support components 200 are arranged at intervals on the water surface along horizontal direction to provide an installation site for a wind turbine 400. The first transverse connector 100 includes a first connecting rod 110 and an outward-extending plate 120. Two ends of the first connecting rod 110 are respectively connected to two adjacent floating support components 200, so as to connect the two adjacent floating support components 200 together. The outward-extending plate 120 extends horizontally from an outer side wall of the first connecting rod 110 in a direction away from a center of the first connecting rod 110. The outward-extending plate 120 extending outward from the outer side wall of the first connecting rod 110 may accelerate the decay of the pitching motion of the floating support components 200.

Since the floating support components 200 move in waves, and their motion equation is Mx′+Bx′+Cx=Fw, where, M is mass matrix, x″ is acceleration vector, B is damping coefficient, x′ is velocity vector, C is hydrostatic stiffness matrix, x is displacement vector and Fw is wave force. The larger the B, the greater the suppression effect on the motion of the floating support components 200. The B is mainly generated by the vortex motion of the fluid. Generally, the more sharp corners and protrusions an underwater structure has, the more likely it is to generate vortex motion. Therefore, in this embodiment, by setting the outward-extending plate 120, the number of sharp corners and protrusions of a underwater part of the floating-type wind power generation platform can be increased, thereby increasing the damping of the rocking motion of the floating-type wind power generation platform and reducing movement amplitude of the floating-type wind power generation platform in waves.

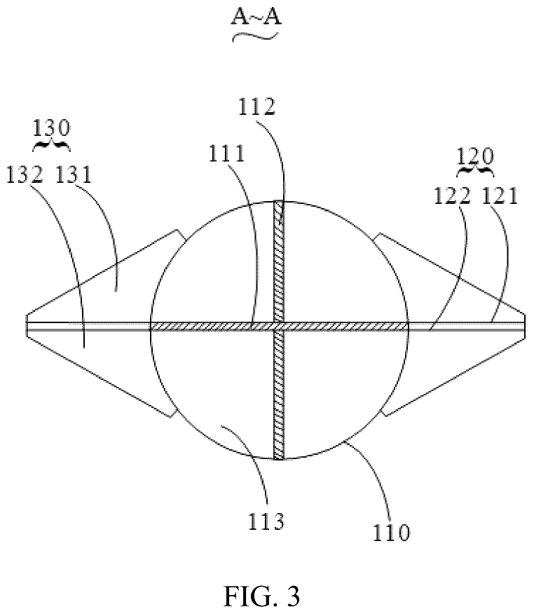

Referring to FIGS. 2 and 3, as one embodiment, the outward-extending plate 120 extends horizontally from the outer side wall of the first connecting rod 110 in a direction away from the center of the first connecting rod 110, that is, the outward-extending plate 120 is horizontally provided. Of course, in specific applications, in an alternative embodiment, the outward-extending plate 120 can be inclined, curved, or follow other shaped trajectories. That is, the outward-extending plate 120 can also extend in an inclined or curved manner from the outer side wall of the first connecting rod 110 in a direction away from the center of the first connecting rod 110.

Referring to FIGS. 1 and 2, as one embodiment, the first connecting rod 110 is provided near the bottoms of the floating support components 200. Of course, in specific applications, the arrangement of the first connecting rod 110 is not limited to this, for example, it can also be provided near the middle of the floating support components 200.

Referring to FIGS. 1 to 3, as one embodiment, the first transverse connector 100 includes two outward-extending plates 120. The two outward-extending plates 120 are respectively protruded from opposite sides of the first connecting rod 110. In this embodiment, by setting the outward-extending plates 120 on both opposite sides of the first connecting rod 110, the sharp corners and protrusions of the underwater part of the floating-type wind power generation platform can be further increased, thereby helping to further reduce the movement amplitude of the floating-type wind power generation platform in waves. Of course, in specific applications, as an alternative implementation, the outward-extending plate 120 can also be set on only one side of the first connecting rod 110.

Referring to FIGS. 1 to 3, as one embodiment, a thickness of the outward-extending plate 120 is within a range of 15 mm to 20 mm. If the thickness of the outward-extending plate 120 is too large, it will lead to an increase in material consumption, thereby increasing cost; and if the thickness of the outward-extending plate 120 is too small, it will make the outward-extending plate 120 prone to be damaged, resulting in insufficient structural stability of the first transverse connector 100. Therefore, in this embodiment, the thickness of the outward-extending plate 120 is set between 15 mm and 20 mm to ensure the structural stability of the first transverse connector 100 while reducing material consumption and lowering costs. Of course, in specific applications, the thickness range of the outward-extending plate 120 is not limited to 15 mm to 20 mm.

Referring to FIGS. 2 to 3, as one embodiment, the connection point between the first connecting rod 110 and the outward-extending plate 120 is at a position where the outer side wall of the first connecting rod 110 has a greatest distance from the center of the first connecting rod 110 in horizontal direction, which helps to maintain the balance of the first connecting rod 110.

Referring to FIGS. 1 to 3, as one embodiment, the floating-type wind power generation platform also includes a reinforcing rib 130. The reinforcing rib 130 is connected to both the outer side wall of the first connecting rod 110 and the outward-extending plate 120. In this embodiment, by setting the reinforcing rib 130, the structural strength of the first transverse connector 100 is enhanced, which helps to prevent damage to the outward-extending plate 120 and extend the service life of the first transverse connector 100.

Referring to FIGS. 1 to 3, as one embodiment, the outward-extending plate 120 has an upper surface 121 and a lower surface 122 that are provided opposite to each other. The reinforcing rib 130 includes a first rib 131 and/or a second rib 132. The first rib 131 is connected to the outer side wall of the first connecting rod 110 and the upper surface 121, and the second rib 132 is connected to the outer side wall of the first connecting rod 110 and the lower surface 122. In this embodiment, by setting the reinforcing rib 130 on both upper and lower sides of the outward-extending plate 120, on one hand, it helps to better prevent damage to the outward-extending plate 120, extending its service life and thereby reducing cost; on the other hand, it can accelerate the decay of the pitching motion of the floating support components 200. Of course, in specific applications, the reinforcing rib 130 can also be set only on the upper surface 121 or the lower surface 122.

As one embodiment, the upper surface 121 and the lower surface 122 are provided opposite to each other in a vertical direction, and both the upper surface 121 and the lower surface 122 each are a horizontal surface. Of course, in specific applications, the arrangement of the upper surface 121 and the lower surface 122 is not limited to this; for example, at least one of the upper surface 121 and the lower surface 122 can also be an inclined surface.

Referring to FIGS. 2 to 3, as one embodiment, a length of the outward-extending plate 120 is less than or equal to a length of the first connecting rod 110. The length of the first connecting rod 110 specifically refers to an axial length of the first connecting rod 110.

Referring to FIGS. 1 to 3, the floating-type wind power generation platform includes at least two reinforcing ribs 130 spaced apart along an axial length direction of the first connecting rod 110. In this embodiment, by setting the reinforcing ribs 130, the number of protruding structures on the first transverse connector 100 is increased, making it easier for vortex motion to occur.

Referring to FIGS. 1 to 3, as one embodiment, the outer side wall of the first connecting rod 110 is cylindrical. The outward-extending plate 120 is collinear with the first connecting rod 110 in horizontal radial direction, which helps to center the outward-extending plate 120 and maintain the balance of the first transverse connector 100. The outer side wall of the first connecting rod 110 is not limited to a cylindrical shape; for example, it can also be rectangular or other polygonal shapes, or elliptical, etc.

Referring to FIG. 3, as one embodiment, the first connecting rod 110 includes a hollow rod body 113 and at least two connecting plates that are cross-connected within the hollow rod body 113 and are used to strengthen the structural stability of the first connecting rod 110.

Referring to FIG. 3, as one embodiment, the at least two connecting plates include a transverse connecting plate 111 and a longitudinal connecting plate 112. Two ends of the transverse connecting plate 111 are connected to parts of the first connecting rod 110 that have a maximum distance from the center of the first connecting rod 110 in horizontal direction, that is, the transverse connecting plate 111 extends radially along the horizontal direction of the first connecting rod 110. Two ends of the longitudinal connecting plate 112 are connected to parts of the first connecting rod 110 that have a maximum distance from the center of the first connecting rod 110 in in vertical direction, that is, the longitudinal connecting plate 112 extends radially along the vertical direction of the first connecting rod 110. The transverse connecting plate 111 and the longitudinal connecting plate 112 are cross-connected with each other at the center of the first connecting rod 110. Of course, in specific applications, the crossing arrangement manner of the connecting plates is not limited to this one.

As one embodiment, the transverse connecting plate 111 and the outward-extending plate 120 are separately provided, and the outward-extending plate 120 is welded to the outer side wall of the hollow rod body 113 (referring to FIG. 3). Of course, in specific applications, as an alternative embodiment, the transverse connecting plate 111 and the outward-extending plate 120 can also be integrally provided, to divide the first connecting rod 110 into an upper half-concave shell and a lower half-concave shell, and the upper half-concave shell and lower half-concave shell are fixed to the top and bottom of the transverse connecting plate 111, with their concave cavities facing the transverse connecting plate 111.

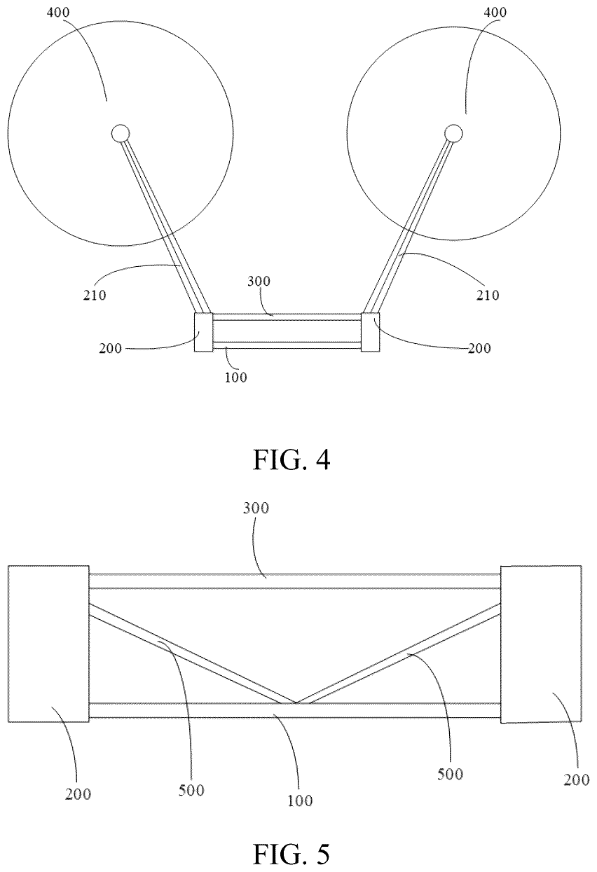

Referring to FIGS. 1 and 4, as one embodiment, the floating support component 200 is a vertical cylindrical float. The wind turbine 400 can be installed at the top of the vertical cylindrical float, or, a support pole 210 can extend upward from the top of the vertical cylindrical float, with the wind turbine 400 installed on the support pole 210. The top of the floating support component 200 extends upward with the wind turbine 400 installed on the support pole 210. Of course, in specific applications, the arrangement of the floating support component 200 is not limited to this; for example, as an alternative embodiment, the floating support component 200 further includes a hull and a support pole 210 extending upward from a top of the hull, with the support pole 210 used to install the wind turbine 400.

Referring to FIG. 1, the structure of the aforementioned floating-type wind power generation platform also includes a second transverse connector 300. Two ends of the second transverse connector are connected to two adjacent floating support components 200 and are provided near the top of the floating support components 200, and the second transverse connector is provided opposite to the first transverse connector 100, to enhance the structural stability of the floating-type wind power generation platform.

Referring to FIG. 4, as one embodiment, this embodiment also provides a floating-type wind power generation system, which includes a wind turbine 400 and the aforementioned floating-type wind power generation platform, where the wind turbine 400 is installed on the floating support component 200.

Referring to FIG. 4, as one embodiment, each floating support component 200 is provided with one wind turbine 400, so that the floating-type wind power generation system has two or more wind turbines 400, which helps to improve power generation efficiency.

Referring to FIG. 4, as one embodiment, the top of the floating support component 200 extends upward with a support pole 210, and the wind turbine 400 is installed on the support pole 210.

### Embodiment 2

Referring to FIGS. 1 and 5, this embodiment provides a floating-type wind power generation platform and a floating-type wind power generation system, which is different mainly from Embodiment 1 in that the floating-type wind power generation platform in this embodiment further includes an inclined connecting rod 500.

As one embodiment, the inclined connecting rod 500 is provided between two adjacent floating support components 200 and is angularly connected between the floating support component 200 and the first transverse connector 100. Specifically, one end of the inclined connecting rod 500 is connected to the floating support component 200, and the other end angularly extends downward to connect to the first transverse connector 100. The inclusion of the inclined connecting rod 500 enhances the structural stability of the floating-type wind power generation platform. Of course, in specific applications, as an alternative embodiment, the inclined connecting rod 500 may not be provided; alternatively, the inclined connecting rod 500 can also be angularly connected between the floating support component 200 and the second transverse connector 300, that is, one end of the inclined connecting rod 500 is connected to the floating support component 200, and the other end extends angularly upward to connect to the second transverse connector 300.

As one embodiment, two inclined connecting rods 500 are provided between two adjacent floating support components 200, where one inclined connecting rod 500 angularly extends downward from one floating support component 200 to the first transverse connector 100, and the other inclined connecting rod 500 angularly extends downward from the other floating support component 200 to the first transverse connector 100. Of course, in specific applications, the number and connection method of the inclined connecting rod 500 are not limited to this.

Apart from the aforementioned differences, other parts of the floating-type wind power generation platform and the floating-type wind power generation system provided in this embodiment can be referred to Embodiment 1, and will not be described in detail here.

The above descriptions merely refer to some embodiments of the present application and do not limit the patent scope of the present application. Any equivalent structural modifications made under the inventive concept of the present application by using the contents of the description and drawings of the present application, or direct or indirect applications in other related technical fields, are included within the scope of the patent protection of the present application.

What is claimed is:

1. A floating-type wind power generation platform, comprising:
a first transverse connector and at least two floating support components, wherein,
the at least two floating support components are arranged at intervals on water surface in a horizontal direction to provide an installation site for a wind turbine; and
the first transverse connector comprises a first connecting rod and an outward-extending plate, two ends of the first connecting rod are respectively connected to two adjacent floating support components, and the outward-extending plate extends from an outer side wall of the first connecting rod in a direction away from a center of the first connecting rod.

2. The floating-type wind power generation platform according to claim 1, wherein the first transverse connector comprises two outward-extending plates, and the two outward-extending plates are respectively protruded from two opposite sides of the first connecting rod.

3. The floating-type wind power generation platform according to claim 1, wherein the outward-extending plate extends horizontally from the outer side wall of the first connecting rod in the direction away from the center of the first connecting rod; and/or,
the first connecting rod is provided near bottoms of the floating support components.

4. The floating-type wind power generation platform according to claim 2, wherein the outward-extending plate extends horizontally from the outer side wall of the first connecting rod in the direction away from the center of the first connecting rod; and/or,
the first connecting rod is provided near bottoms of the floating support components.

5. The floating-type wind power generation platform according to claim 1, wherein a position where the first connecting rod is connected with the outward-extending plate is a position where the outer side wall of the first connecting rod has a greatest horizontal distance from the center of the first connecting rod.

6. The floating-type wind power generation platform according to claim 2, wherein a position where the first connecting rod is connected with the outward-extending plate is a position where the outer side wall of the first connecting rod has a greatest horizontal distance from the center of the first connecting rod.

7. The floating-type wind power generation platform according to claim 1, wherein a length of the outward-extending plate is less than or equal to a length of the first connecting rod.

8. The floating-type wind power generation platform according to claim 2, wherein a length of the outward-extending plate is less than or equal to a length of the first connecting rod.

9. The floating-type wind power generation platform according to claim 1, wherein the first transverse connector further comprises a reinforcing rib, and the reinforcing rib is connected to both the outer side wall of the first connecting rod and the outward-extending plate.

10. The floating-type wind power generation platform according to claim 2, wherein the first transverse connector further comprises a reinforcing rib, and the reinforcing rib is connected to both the outer side wall of the first connecting rod and the outward-extending plate.

11. The floating-type wind power generation platform according to claim 9, wherein the outward-extending plate has an upper surface and a lower surface that are disposed opposite to each other, and the reinforcing rib comprises at least one of a first rib and a second rib, wherein the first rib is connected between the outer side wall of the first connecting rod and the upper surface, and the second rib is connected between the outer side wall of the first connecting rod and the lower surface; and/or,
the first transverse connector comprises at least two reinforcing ribs spaced apart in a length direction of the first connecting rod.

12. The floating-type wind power generation platform according to claim 10, wherein the outward-extending plate has an upper surface and a lower surface that are disposed opposite to each other, and the reinforcing rib comprises at least one of a first rib and a second rib, wherein the first rib is connected between the outer side wall of the first connecting rod and the upper surface, and the second rib is connected between the outer side wall of the first connecting rod and the lower surface; and/or,
the first transverse connector comprises at least two reinforcing ribs spaced apart in a length direction of the first connecting rod.

13. The floating-type wind power generation platform according to claim 1, wherein the outer side wall of the first connecting rod is cylindrical; and/or,
the first connecting rod comprises a hollow rod body and at least two connecting plates that are cross-connected within the hollow rod body.

14. The floating-type wind power generation platform according to claim 2, wherein the outer side wall of the first connecting rod is cylindrical; and/or,
the first connecting rod comprises a hollow rod body and at least two connecting plates that are cross-connected within the hollow rod body.

15. The floating-type wind power generation platform according to claim 1, wherein the floating support components are a vertical cylindrical float; or
the floating support components comprise a hull and a support pole extending upward from a top of the hull for installing the wind turbine.

16. The floating-type wind power generation platform according to claim 2, wherein the floating support components are a vertical cylindrical float; or
the floating support components comprise a hull and a support pole extending upward from a top of the hull for installing the wind turbine.

17. A floating-type wind power generation system, comprising:
a wind turbine and the floating-type wind power generation platform according to claim 1, wherein the wind turbine is installed on the floating support components.

18. The floating-type wind power generation system according to claim 17, wherein the first transverse connector comprises two outward-extending plates, and the two outward-extending plates are respectively protruded from two opposite sides of the first connecting rod.

19. The floating-type wind power generation system according to claim 17, wherein the outward-extending plate extends horizontally from the outer side wall of the first connecting rod in the direction away from the center of the first connecting rod; and/or,
the first connecting rod is provided near bottoms of the floating support components.

20. The floating-type wind power generation system according to claim 17, wherein a position where the first connecting rod is connected with the outward-extending plate is a position where the outer side wall of the first connecting rod has a greatest horizontal distance from the center of the first connecting rod.
